(19) United States
(12) Patent Application Publication
(10) Pub. No.: US 2025/0277501 A1
(43) Pub. Date: Sep. 4, 2025

(54) JOINERY ARRANGEMENT COMPRISING INTERLOCKED JOINERY COMPONENTS

(71) Applicant: Välinge Innovation AB, Viken (SE)

(72) Inventors: Oscar RYDSJÖ, Halmstad (SE); Peter DERELÖV, HELSINGBORG (SE)

(73) Assignee: Välinge Innovation AB, Viken (SE)

(21) Appl. No.: 19/068,325

(22) Filed: Mar. 3, 2025

(30) Foreign Application Priority Data
Mar. 4, 2024 (SE) 2450248-6

(51) Int. Cl. F16B 12/10

(52) U.S. Cl. CPC F16B 12/10; F16B 2012/103

(57) ABSTRACT

The disclosure relates to a joinery arrangement including a first and a second joinery component configured to be locked to each other. The first joinery component includes at least one cavity and a recess and the second joinery component includes at least one protrusion and an insert. The insert is displaceable and/or compressible along its main direction. The cavities and the protrusions are configured to cooperate with each other for locking the first and second joinery components to each other in a first direction and the recess and the insert are configured to cooperate with each other for locking the first and second joinery components to each other in a second direction. The insert includes a retaining member including at least one projection. The retaining member is configured to cooperate with the recess and/or an insert groove in a locked state.

### TECHNICAL FIELD

The disclosure relates to a joinery arrangement comprising joinery components configured to be locked to each other. The joinery arrangement may be included in a joinery assembly, such as a furniture assembly. The disclosure also relates to a joinery assembly comprising the joinery arrangement and additional joinery components.

### BACKGROUND

WO 2023/191694 A1 discloses a locking device comprising a spring and a locking part, such as locking pin or a locking disc, for locking two elements, such as a first and a second panel, to one another. The first and/or second panels may be furniture components which may be a part of a furniture product. The locking pin may comprise an end part in the shape of a truncated cone, which may facilitate the locking of the two panels to one another.

Notwithstanding the advantages of the technology above, certain products, such as including furniture components, may require an even better locking performance.

### SUMMARY

It is therefore an object of at least embodiments of the present disclosure to provide a joinery arrangement whose locking configuration is more resistant to high load, and especially to high impulse forces.

Another object of at least embodiments of the present disclosure is to provide such a joinery arrangement while maintaining the possibility to disassemble the joinery arrangement without damaging the joinery components.

Yet another object of at least embodiments of the present disclosure is to provide a corresponding joinery assembly comprising such a joinery arrangement.

These and other objects and advantages that will be apparent from the description have been achieved by the various aspects, embodiments and examples described below.

In accordance with a first aspect of the disclosure, there is provided a joinery arrangement comprising a first joinery component and a second joinery component configured to be locked to each other to obtain a locked state. The first joinery component comprises at least one cavity arranged in a mounting side of the first joinery component and extending along a cavity direction at a cavity angle with respect to a first plane extending along the mounting side of the first joinery component, and a recess arranged in the mounting side of the first joinery component. The second joinery component comprises at least one protrusion arranged in a mounting area of the second joinery component and extending along a protrusion direction at a protrusion angle with respect to a second plane extending along the mounting area of the second joinery component, and an insert arranged in the mounting area of the second joinery component, wherein the insert is displaceable and/or compressible along its main direction. The at least one cavity and the at least one protrusion are configured to cooperate with each other for locking the first and second joinery components to each other in a first direction perpendicular to said first plane. The recess and the insert are configured to cooperate with each other for locking the first and second joinery components to each other in a second direction along the first plane. The insert comprises a retaining member comprising at least one projection, such as a plurality of projections. The retaining member is configured to cooperate with a recess wall of the recess in the locked state. Alternatively, or additionally, the insert is arranged in the insert groove of the second joinery component, and the retaining member is configured to cooperate with a groove wall of the insert groove in the locked state.

By means of the retaining element in accordance with the present disclosure, higher friction between the insert and the recess and/or insert groove may be provided, such that the positioning of the insert in the recess and/or insert groove is better secured. For example, the insert may be prevented from sliding out of the recess and/or insert groove to a higher degree. Thereby, a higher locking strength may be obtained, and an unlocking of the joinery arrangement may be counteracted or even prevented when the first joinery component is subject to high load, and especially high impulse forces, along the first direction.

The joinery arrangement may be included in a joinery assembly, such as a furniture assembly. For example, the furniture assembly may be a cabinet assembly or a shelf assembly. It is emphasized that embodiments of the first and second aspects described herein are particularly suitable for a wall-mounted cabinet assembly, especially including a first joinery component forming a bottom, such as a bottommost, joinery component of the wall-mounted cabinet assembly.

The joinery components herein may be furniture components, such as cabinet components or shelf components. For example, the joinery components may be panels.

The joinery components herein may be wood-based joinery components, preferably comprising a core and, optionally, a décor structure, such as a décor layer attached, such as adhered, to the core. For example, the core may be a high-density fibre, HDF, board, a medium-density fibre, MDF, board, a particle board, or a plywood board. Moreover, the décor structure may be or may comprise a décor layer, such as a foil, a paper, a polymer-based layer, a laminated layer, or a wood veneer. Alternatively, or additionally, the décor structure may comprise a painted surface layer. The cavities, the recess and the insert groove (defined below) may be arranged in the core.

The cooperation, such as engagement, between the cavities and the protrusions as well as between the recess and the insert may define a locked state of the first and second joinery components. Furthermore, an unlocked state of the joinery components may be obtained when there is no cooperation between the cavity and the protrusion and/or the recess and the insert.

A transverse direction of the insert may be perpendicular to the main direction.

For simplicity of the presentation herein, reference will often be made to “projections” (or “cavities” or “protrusions”) instead of “at least one projection (or cavity or protrusion)”, but it is emphasized that “at least one projection (or cavity or protrusion)”, “at least two projections (or cavities or protrusions)” and “a plurality of projections (or cavities or protrusions)” are included in the concept of “projections” (or “cavities” or “protrusions”).

Generally herein, cooperating objects, such as surfaces, portions, members or elements, may cooperate by direct engagement or indirectly. Examples of cooperating objects include the cavities and protrusions, and the recess and the insert. In any embodiment described herein, there may be a sealing agent, such as a wax or an adhesive, provided between the cooperating objects, thereby providing examples of an indirect engagement.

The retaining member may be a friction element for increasing friction between the insert and the recess.

The projections may be separated from each other along the main direction of the insert by a spacing. For example, the projections may form corrugations on the insert. Thereby, a localized pressure from the retaining member against the recess may be provided.

In some embodiments, the projections may be evenly spaced. This may be advantageous when the first joinery component comprises a high-density board, such as high-pressure laminate, HPL, board, and/or a substantially homogeneous board.

The level of friction may be further fine-tuned to fit the material configuration, such as density profile, of the joinery components by adapting the spacings between the projections. Generally, the spacing may vary between different adjacent pairs of projections.

In some embodiments, the spacing between a first pair of adjacent projections may be smaller than the spacing between a second pair of adjacent projections, wherein the first pair is arranged closer than the second pair to an end section of the insert. Smaller and larger spacings between the projections may provide a lower and higher pressure (and/or force) and friction against the core of the joinery component, respectively. Hence, a higher pressure (and/or force) and higher friction between the insert and the recess may be provided in an outer region of the joinery component than in an inner region of the joinery component arranged inside of the outer region along a thickness direction of the joinery component. For example, a wood-based first joinery component, preferably comprising a core in the form of an HDF board, an MDF board, a particle board, or a plywood board, and a décor structure, for example a décor layer comprising a polymer-based layer, a laminated layer or a wood veneer, may comprise a higher density in the outer region than in the inner region. Thereby, varying spacings may be particularly suitable for use together with such wood-based first joinery components since higher friction may be provided in the high-density region.

Another effect of the smaller spacing between the adjacent projections is that an adjusted pressure profile (and/or force profile) may be obtained, such that a sufficient locking strength may be provided while maintaining the possibility to disassemble the joinery components without damaging them. This may be particularly important for a wood-based first joinery component comprising a varying density profile as described above, for example comprising a core in the form of an HDF board, an MDF board, a particle board, or a plywood board, and a décor structure as described above.

In some embodiments, the projections may be separated from each other along a circumferential direction of the insert by a spacing.

The projections may extend around an entire circumference of the retaining member. Thereby, a simpler positioning of the insert into an insert groove may be provided. Additionally, at least in some applications, the manufacturing of the insert, such as by injection moulding, may become simpler.

The retaining member may generally taper in a longitudinal direction towards an end section of the insert. For example, transverse extensions of the projections may decrease towards the end section. Alternatively, or additionally, the recess wall may taper in a depth direction of the recess. For example, an end portion of the insert and/or the recess wall may have a frustoconical shape. Thereby, a larger contact area between the insert comprising projections and the recess may be provided, especially for a less dense core material, for example a particle board, whereby a higher locking strength along the first direction may be obtained. In addition, the wear of the recess may be reduced during disassembly of the joining arrangement.

Respective ones of the projections may extend, from a base surface of the retaining member, by different heights.

At least some of the projections may extend, from a base surface of the retaining member, up to a virtual frustoconical surface, which forms a non-zero angle relative to the base surface.

Transverse extensions of the projections may decrease along the main direction of the insert in a direction towards an end section of the insert.

In the locked state, a locking portion of the insert, such as of the retaining member, may cooperate with a locking surface of the recess and, optionally, there may be a play between a head surface of a head portion of the insert and a recess wall, preferably arranged opposite to the cooperating recess wall of the recess.

The mounting side of the first joinery component may be provided in a first face of the first joinery component. The mounting area may be provided in a first side edge of the second joinery component.

During locking, the insert may be configured to be compressed such that it assumes a compressed state, and, subsequently, the insert may be at least partially expanded towards an expanded state for locking the second joinery component to the first joinery component. For example, the insert may lock against the recess by pretension.

The second joinery component may be configured to be locked to the first joinery component by relatively displacing the second joinery component with respect to the first joinery component in a locking direction extending essentially in parallel with at least one of the cavity direction and the protrusion direction.

The insert may be separately formed from the second joinery component. For example, the insert, including the retaining member and/or a body portion and serpentine elements (defined below), may be formed by injection moulding.

The insert may be arranged in an insert groove of the second joinery component.

The insert and/or an insert groove in which the insert is arranged may essentially extend along a normal direction of the second plane. Thereby, it may become easier to form the insert groove, such as by drilling.

The retaining member may comprise an outer and/or an inner retaining member. The outer (or inner) retaining member may be configured to cooperate with the recess (or the insert groove) in the locked state. It is emphasized that in some embodiments, the retaining member may comprise only an inner retaining member.

The at least one projection may be arranged in a body portion of the insert, wherein the body portion is configured to cooperate with a groove wall of the insert groove in the locked state. Thereby, a higher locking strength may be provided, and an unlocking of the joinery arrangement may be further counteracted or even prevented when the first joinery component is subject to high load, and especially high impulse forces, along the first direction. In addition, the insert may be better secured in the insert groove during said high load.

The insert may comprise a spring, such as a static load spring.

The insert may comprise a plurality of joined serpentine elements. The serpentine elements may be flexible and may implement a compressibility of the insert along the main direction, such as axial direction.

The protrusion angle may be smaller than the cavity angle in an unlocked state of the first and the second joinery components. Thereby, the first and second joinery components may be locked to each other by pretension. The protrusion angle may differ from the cavity angle by 0.5° to 6°, such as 2° to 4°, in the unlocked state. For example, the protrusion angle may be smaller than the cavity angle as described above.

Generally herein, the cavity angle and/or the protrusion angle may be acute, for example with respect to the first and/or the second plane. In non-limiting examples, the cavity angle may be between 20° and 75°, such as 30° to 60°, for example about 45° and/or the protrusion angle may be between 20° and 75°, such as 30° to 60°, for example about 42°.

The protrusion angle and the cavity angle may generally herein be measured in the unlocked state and in the locked state by a CT scanner.

Opposing walls of each cavity may be substantially parallel. A cross-section of the cavity and/or the recess may be circular.

In accordance with a second aspect of the disclosure, there is provided a joinery assembly comprising the joinery arrangement according to any of the embodiments of the first aspect and further comprising at least one additional joinery component, such as a plurality of additional joinery components. Embodiments of the second aspect are largely analogous to those of the first aspect, especially embodiments of the joinery arrangement, whereby reference is made thereto.

The joinery assembly may be a furniture assembly, such as a cabinet assembly or a shelf assembly.

Generally, all terms used herein, such as in the claims, are to be interpreted according to their ordinary meaning in the technical field, unless explicitly defined otherwise. All references to “a/an/the [element, device, component, means, step, etc.]” are to be interpreted openly as referring to at least one instance of said element, device, component, means, step, etc., unless explicitly stated otherwise. Reference to one or a plurality of “at least one element”, etc., may shortly be referred to as “the element(s)”.

### BRIEF DESCRIPTION OF THE DRAWINGS

The disclosure will in the following be described in connection to exemplary embodiments and in greater detail with reference to the appended exemplary drawings, wherein:

FIGS. 1a-1c illustrate in a top view (FIG. 1a) and a cross-sectional side view (FIG. 1b) along the section B-B in FIG. 1a an exemplary embodiment of a joinery arrangement during locking, and in a partially sectional perspective view (FIG. 1c) an exemplary embodiment of a joinery arrangement in an unlocked state.

FIGS. 2a-2c illustrate in a cross-sectional side view along the section B-B in FIG. 1a an exemplary embodiment of a joinery arrangement during locking (FIG. 2a), in a partially sectional perspective view an exemplary embodiment of a joinery arrangement in a locked state (FIG. 2b), and in a cross-sectional side view an exemplary embodiment of a second joinery component without any insert and with one protrusion removed (FIG. 2c).

FIG. 2d illustrates in front views an exemplary embodiment of an insert in an expanded state (left subfigure) and in a compressed state (right subfigure).

FIGS. 3a-3b illustrate in a cross-sectional side view (FIG. 3a) along the section B-B in FIG. 1a and a corresponding enlarged cross-sectional side view (FIG. 3b) an exemplary embodiment of a joinery arrangement in a locked state.

FIGS. 4a-4c illustrate in a front view (FIG. 4a), a side view (FIG. 4b) and a perspective view (FIG. 4c) an exemplary embodiment of an insert in an expanded state.

FIGS. 4d-4f illustrate in a front view (FIG. 4d), a side view (FIG. 4e) and a perspective view (FIG. 4f) an exemplary embodiment of an end portion of an insert in an expanded state, which, e.g., may replace the end portions in FIGS. 4a-4c.

FIGS. 5a-5c illustrate in a perspective view (FIG. 5a) and in an enlarged front view (FIG. 5b) and an enlarged side view (FIG. 5c) an exemplary embodiment of an insert in an expanded state.

FIGS. 5d-5f illustrate in a perspective view (FIG. 5d) and in an enlarged front view (FIG. 5e) and an enlarged side view (FIG. 5f) an exemplary embodiment of an insert in an expanded state.

FIGS. 6a-6c illustrate in (enlarged) cross-sectional side views along a section B-B similar to that in FIG. 1a exemplary embodiments of a joinery arrangement in a locked state.

FIGS. 6d-6f illustrate in a perspective view (FIG. 6d) and in an enlarged front view (FIG. 6e) an exemplary embodiment of an insert in an expanded state, and in an enlarged side view (FIG. 6f) an exemplary embodiment of a joinery arrangement using such an insert in a locked state, corresponding to FIG. 6c.

FIGS. 7a-7b illustrate in an enlarged front view (FIG. 7a) an exemplary embodiment of an insert, and in an enlarged side view (FIG. 7b) an exemplary embodiment of a joinery arrangement using such an insert in a locked state.

FIGS. 7c-7e illustrate in a perspective view (FIG. 7c) and in an enlarged front view (FIG. 7d) an exemplary embodiment of an insert, and in an enlarged side view (FIG. 7e) an exemplary embodiment of a joinery arrangement using such an insert in a locked state.

FIGS. 7f-7h illustrate in an enlarged perspective view (FIG. 7f) and in an enlarged front view (FIG. 7g) an exemplary embodiment of an insert, and in an enlarged side view (FIG. 7h) an exemplary embodiment of a joinery arrangement using such an insert in a locked state.

FIGS. 8a-8c illustrate in a perspective view (FIG. 8a) and in an enlarged front view (FIG. 8b) an exemplary embodiment of an insert, and in an enlarged side view (FIG. 8c) an exemplary embodiment of a joinery arrangement using such an insert in a locked state.

FIGS. 8d-8g illustrate in frontal (FIG. 8d) and rear (FIG. 8e) perspective views an exemplary embodiment of an insert, and in enlarged side views an exemplary embodiment of a joinery arrangement using such an insert (FIG. 8f) in a locked state, and an alternative exemplary embodiment of a joinery arrangement using an insert (FIG. 8g) in a locked state.

FIGS. 8h-8j illustrate in a perspective view (FIG. 8h) and in an enlarged front view (FIG. 8i) an exemplary embodiment of an insert, and in an enlarged side view (FIG. 8j) an exemplary embodiment of a joinery arrangement using such an insert in a locked state.

FIGS. 9a-9b illustrate in a perspective view an exemplary embodiment of a joinery assembly during assembly (FIG. 9a) and in an assembled state (FIG. 9b), e.g., including any of the joinery arrangements and/or inserts in FIGS. 1a-1c, 2a-2d, 3a-3b, 4a-4f, 5a-5f, 6a-6f, 7a-7h and 8a-8j.

FIGS. 10a-10c illustrate a side view (FIG. 10a), a front view (FIG. 10b), and a top view (FIG. 10c), samples of a joinery arrangement and a rig used for testing them in an impact load testing method.

FIGS. 11a-11c illustrate in diagrams measured test results of a peak load testing method (FIG. 11a) and of the impact load testing method (FIGS. 11b-11c) in FIGS. 10a-10c for various samples of a joinery assembly.

### DETAILED DESCRIPTION

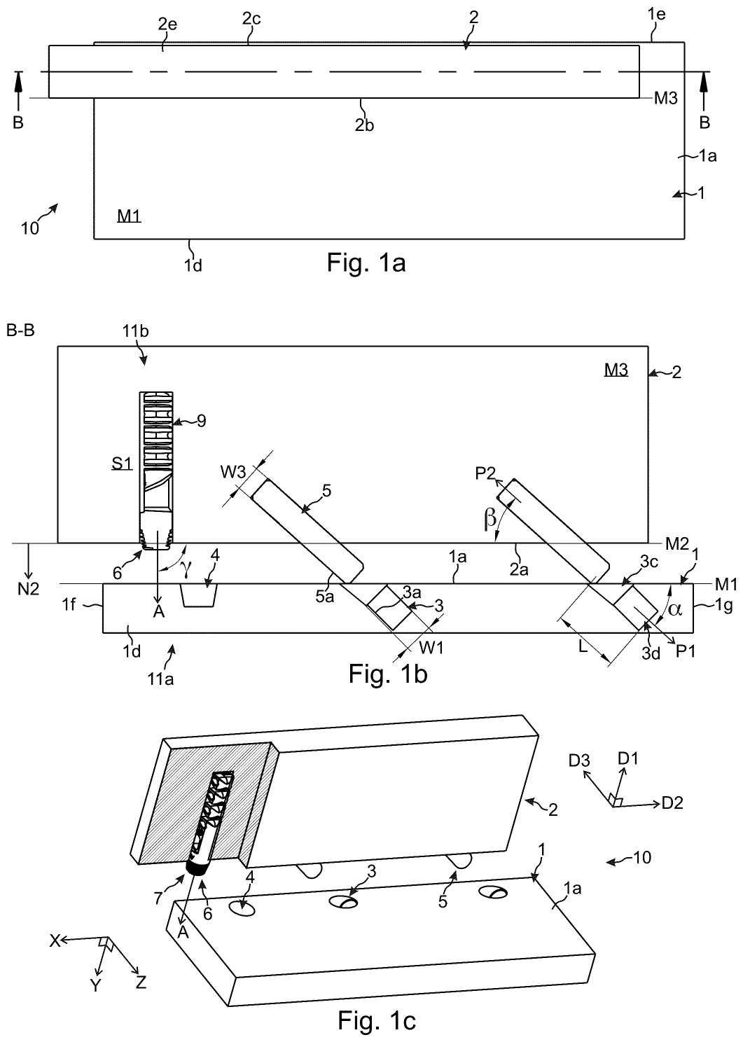

Next, various embodiments of a joinery arrangement 10 and a corresponding joinery assembly 20 will be described with reference to, e.g., FIGS. 1a-1c, 2a-2d, 3a-3b, 4a-4f, 5a-5f, 6a-6f, 7a-7h, 8a-8j, 9a-9b and 10a-10c.

The disclosure relates to a joinery arrangement 10 comprising a first 1 and a second 2 joinery component. The joinery components 1, 2 may be furniture components, such as cabinet components or shelf components. For example, the joinery components may be panels, such as furniture panels.

The first (or second) joinery component 1 (or 2) may comprise a first face 1b (or 2b), a second face 1c (or 2c) opposite to the first face 1b (or 2b). Moreover, the first (or second) joinery component 1 (or 2) may further comprise a pair of opposing first 1d (or 2d) and second 1e (or 2e) side edges and a pair of side portions 1f, 1g (or 2f, 2g) extending between the faces 1b, 1c (or 2b, 2c) and between the side edges 1d, 1e (or 2d, 2e).

The first 1 and/or the second 2 joinery components may be wood-based joinery components, preferably comprising a core 18 and, optionally, a décor structure 19, such as a decor layer attached to the core 18. For example, the core 18 may be an HDF board, an MDF board, a particle board, a HPL board, or a plywood board. Moreover, the décor layer may be or may comprise a foil, a paper, polymer-based layer, a laminated layer, or a wood veneer. For example, the polymer-based layer may comprise a thermosetting resin, such as a melamine-formaldehyde resin, or thermoplastic polymers, such as polyvinyl chloride, PVC. Alternatively, or additionally, the décor structure 19 may comprise a painted surface layer.

The first joinery component 1 comprises at least one cavity 3, such as a plurality of cavities 3, and a recess 4. The cavities 3 are arranged in a mounting side 1a of the first joinery component 1 and extend along a cavity direction P1 at a, preferably acute, cavity angle α with respect to a first plane M1 extending along the mounting side 1a. The mounting side 1a may be provided in the first face 1b. The recess 4 is arranged in the mounting side 1a. The cavity angle α may be between 20° and 75°, such as 30° to 60°, for example about 45°. The second joinery component 2 comprises at least one protrusion 5, such as a plurality of protrusions 5, and an insert 6. The protrusions 5 are arranged in a mounting area 2a of the second joinery component 2 and extend along a protrusion direction P2 at a, preferably acute, protrusion angle β with respect to a second plane M2 extending along the mounting area 2a. The mounting area 2a may be provided in the first side edge 2d. The protrusion angle β may be between 20° and 75°, such as 30° to 60°, for example about 42°.

Each protrusion 5 may be axially rigid. Thereby, it may be substantially incompressible along its axial direction. Each protrusion 5 may be a rod-shaped element, such as a cylinder-shaped element. The protrusions 5 may be arranged in a hole 5c, preferably by means of a press fit and/or an adhesive. The holes 5c may be formed by drilling and may be inclined by an angle corresponding to the protrusion angle β. A cross-section of each protrusion 5 along the protrusion direction P2 preferably is circular. Preferably, the protrusions 5 are separately formed from the second joinery component member 2. For example, they may be plugs or dowels, preferably polymer-based dowels or wood dowels.

The insert 6 is arranged in the mounting area 2a and is preferably arranged in an insert groove 9 of the second joinery component 2. The insert 6 is displaceable and/or compressible along its main direction A, such as by being spring loaded. The main direction A may be an axial direction of the insert.

A, preferably maximal, length K of the protrusions 5 and/or a depth L of the cavities 3 may be 20-60 mm, such as 30-40 mm. A, preferably maximal, width W1, W3 of the cavities 3 and/or protrusions 5 may be 5-10 mm, preferably about 8 mm. A, preferably maximal, width W4, W5 of the insert 6 and/or insert groove 9 may be 5-12 mm, such as 5-10 mm or 8-12 mm. Likewise, a preferably maximal, width W2 of the recess 4 may be 5-12 mm, such as 7-11 mm or 8-12 mm.

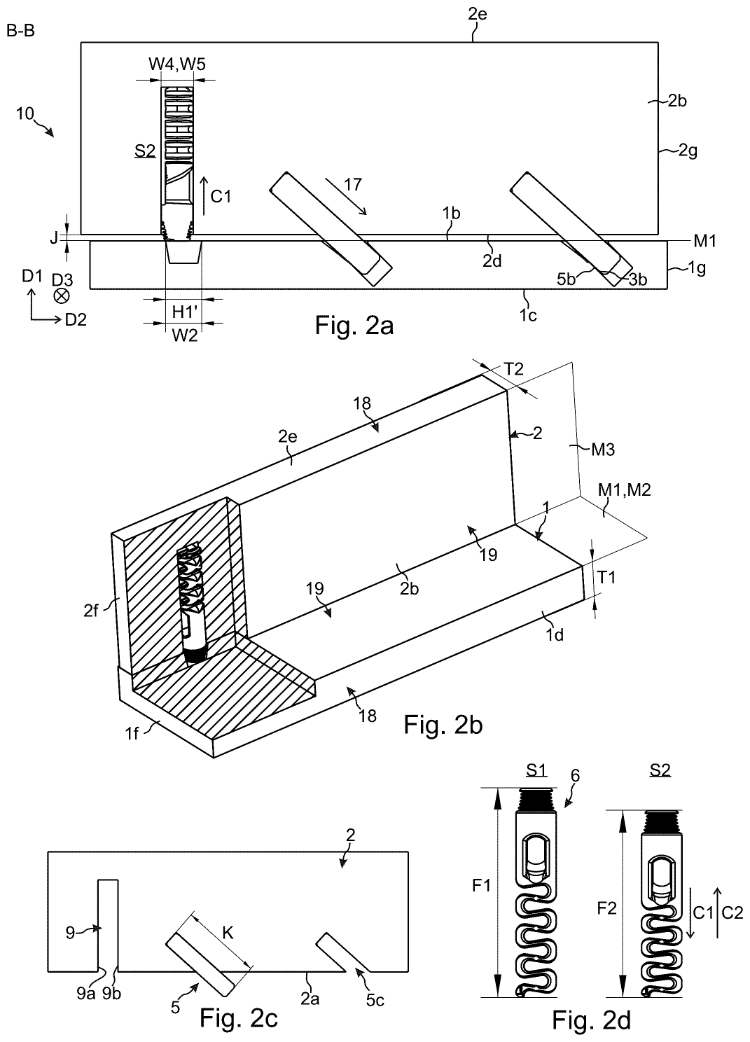

The cavities 3 and protrusions 5 are configured to cooperate, such as engage, with each other for locking the first 1 and second 2 joinery components to each other in a first direction D1 perpendicular to the first plane M1. Each protrusion 5 may be received in a respective cavity 3 for cooperation therebetween. Moreover, the recess 4 and the insert 6 are configured to cooperate, such as engage, with each other for locking the first 1 and second 2 joinery components in a second direction D2 along the first plane M1. Thereby, a locked state of the first 1 and second 2 joinery components in the first D1 and second D2 directions may be obtained, see, e.g., FIGS. 2b, 3a-3b, 6a-6c, 6f, 7b, 7e, 7h, 8c, 8f-8g, 8j and 9b. Preferably, the first D1 and second D2 directions are perpendicular to each other. Clearly, the cavities 3 and the protrusions 5 may optionally also contribute to the locking of the second joinery component 2 to the first joinery component 1 in the second direction D2. In addition, the cavities 3 and the protrusions 5 and/or the recess 4 and the insert 6 may contribute to the locking of the second joinery component 2 to the first joinery component 1 in a third direction D3, which is perpendicular to the first D1 and second D2 directions. The cavities 3 and protrusions 5 and the recess 4 and the insert 6 may provide a locking device of the joinery arrangement.

A third plane M3 extending along the face 2b and/or 2c may be configured to be arranged perpendicularly to the first plane M1 in the locked state.

The protrusions 5 may cooperate with the respective cavities 3 at connecting surfaces 3b, 5b which may be arranged in a wall 3a of the cavities 3 and in a wall 5a of the protrusions. The connecting surfaces 3b, 5b may extend around a portion of a circumference of the protrusions and cavities, such as around their entirety.

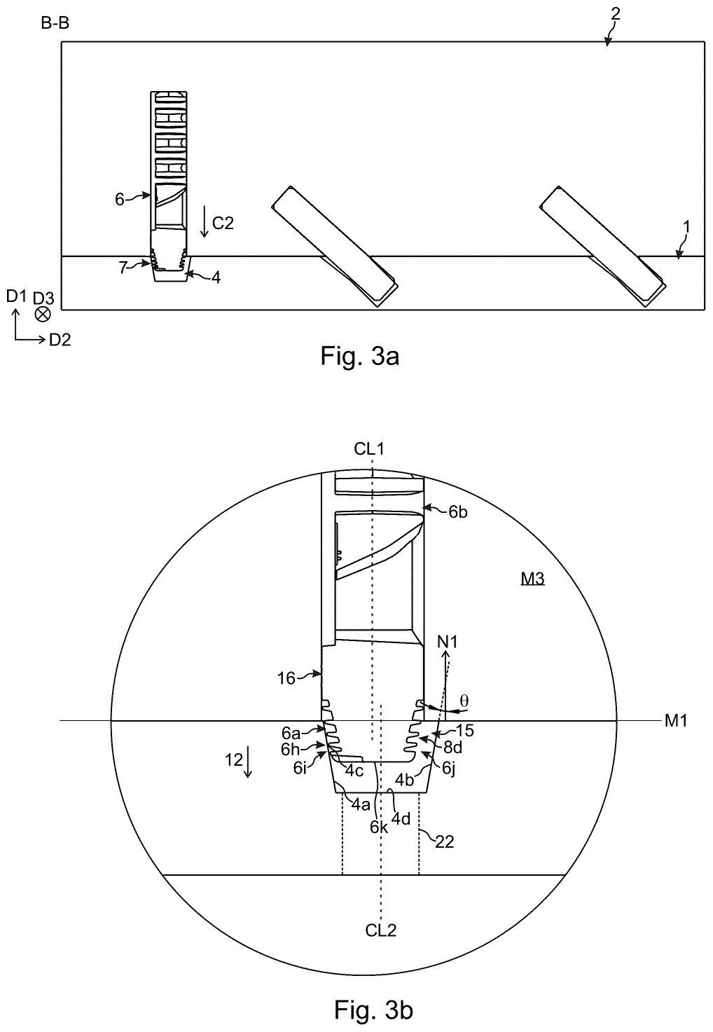

The insert 6 may comprise a head portion 6g, which preferably is generally tapering. The insert 6 may comprise a locking portion 6h configured to cooperate with a locking surface 4c of the recess 4, preferably arranged in a recess wall 4a, for locking the joinery components 1, 2 in the second direction D2, see, e.g., FIGS. 3b, 6a, 6c and 10a. Preferably, a transversely inner head portion 6j (or an outer head portion 6i) facing an oppositely arranged recess wall 4b and arranged opposite to the locking portion 6h is spaced from the oppositely arranged recess wall 4b by a play 15. The locking portion 6h and the inner 6j (or outer 6i) head portion may be provided in the head portion 6g. For example, in the locked state, the inner 6j (or outer 6i) head portion may be closer than the locking portion 6h to the cavities 3 and/or protrusions 5 along the D2 direction. For example, a head length HL of the head portion 6g may be 3-7 mm, such as 4-6 mm.

In the locked state, the insert 6, such as a topmost portion 6k along the main direction A, may be spaced from a bottom wall 4d of the recess 4.

Preferably, the cavities 3 and/or the recess 4 are blind holes. Moreover, the cavities 3 and/or the recess 4 may be circumscribed holes, such that they have extensions H1, H2, H1′, H2′ in the mounting area 2a along a pair of non-parallel, such as perpendicular, horizontal directions that are substantially the same. For example, they may be essentially circular or oval holes, preferably formed by drilling. A cross-section of each cavity 3 along the cavity direction P1 preferably is circular, preferably such that a cavity entrance into the mounting side 1a is oval. Alternatively, or additionally, a cross-section of the recess 4, such as along the first direction D1, preferably is circular. Optionally, a cavity inlet 3c is wider than an inner cavity portion 3d, e.g., being formed by a countersink drill bit.

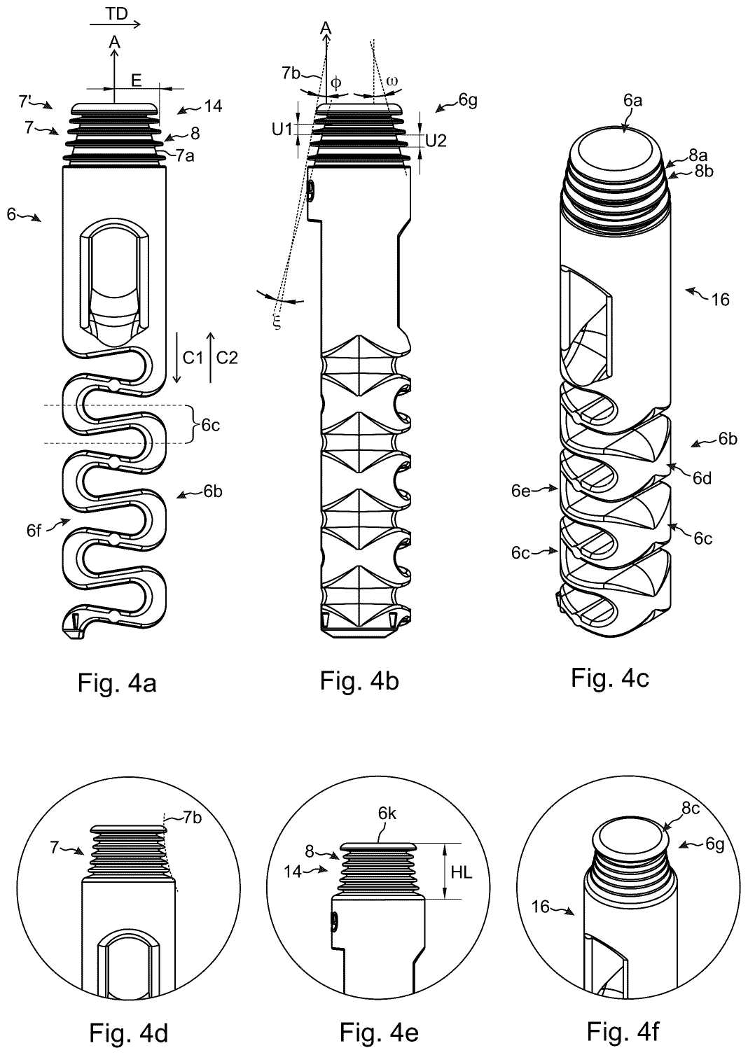

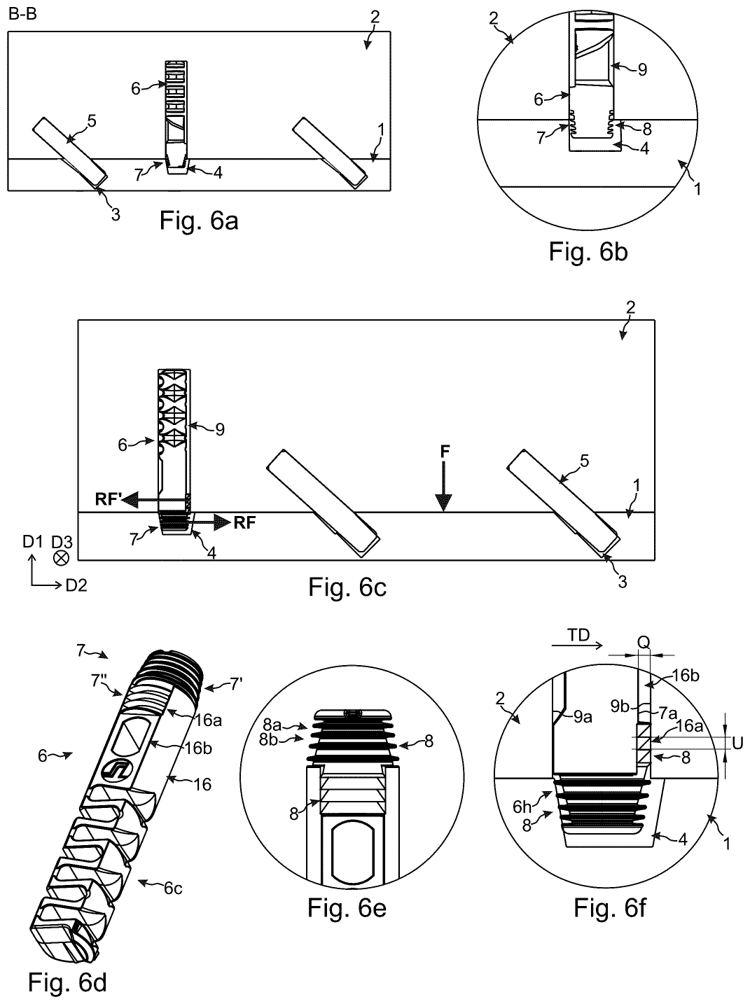

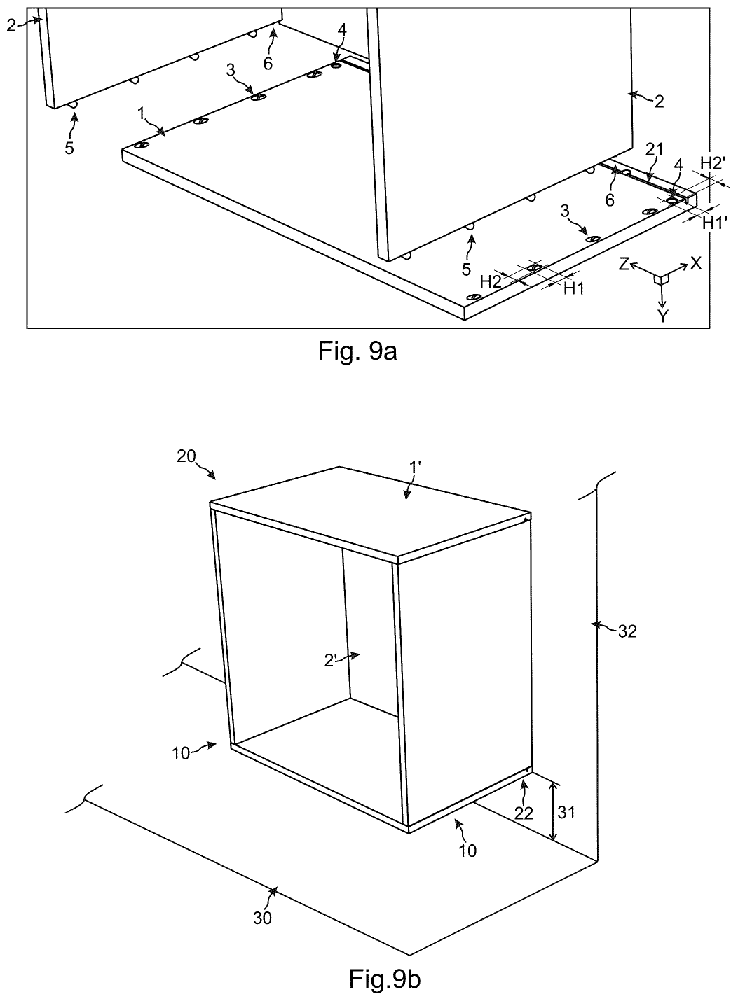

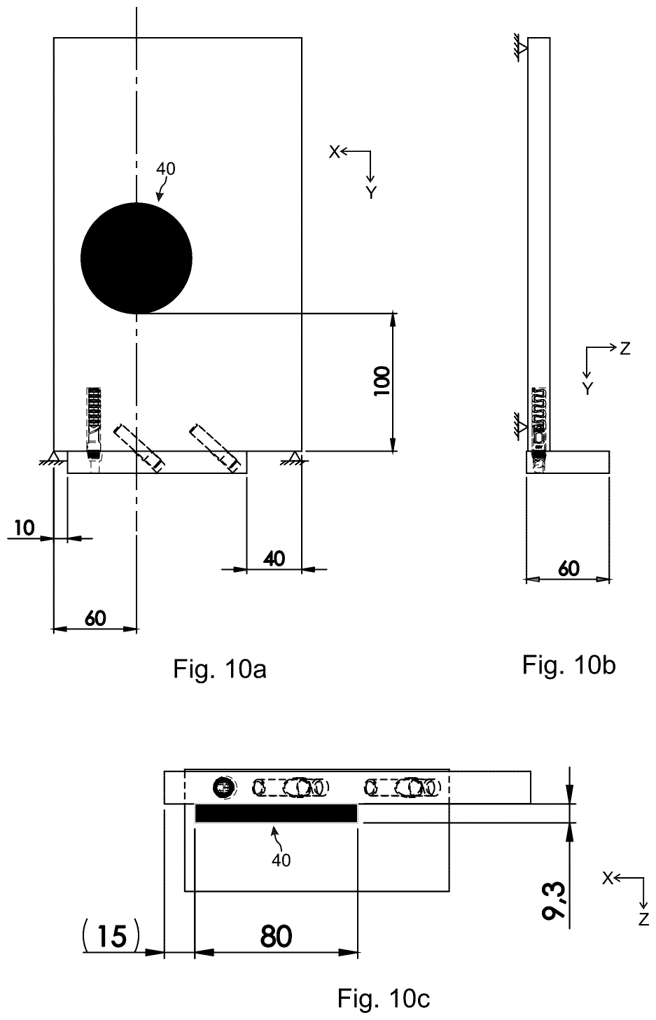

As shown most clearly in FIGS. 1b-1c, 2a-2c, 3a, 6c and 9a, the recess 4 may be arranged in an edge portion 11a of the joinery component 1 and/or the insert 6 may be arranged in an edge section 11b of the second joinery component 2. For example, the recess 4 may be arranged outside of each cavity 3 along the second direction D2 and the insert 6 may be arranged outside of each protrusion 5 along the second direction D2. Thereby, as shown in FIG. 3b, an unlocking hole 22 in the first joinery component 1, such as that shown and discussed in relation to FIG. 10 in WO 2024/019644 A1, e.g., on page 17, lines 1-24, communicating with the recess 4 and configured to provide access to the insert 6 may be more easily concealed, cf. FIGS. 9a-9b. However, as shown in FIG. 6a, in some embodiments the recess 4 may be arranged between a pair of cavities 3. This is also shown and discussed in relation to, e.g., FIGS. 4-10 in WO 2024/019644 A1, which content hereby is explicitly incorporated by reference.

In some embodiments, the protrusion angle B may be smaller than the cavity angle α in an unlocked state of the joinery components 1, 2. For example, the protrusion angle β may differ from the cavity angle a by 0.5° to 6°, such as 2° to 4°, in the unlocked state.

In some embodiments, however, the protrusion angle β may be essentially the same as the cavity angle α, for example differing by less than 0.5°, such as being about 0°.

In preferred embodiments, the insert 6 is separately formed from the second joinery component 2, for example being formed by injection moulding. The insert 6 may comprise a polymer-based material, such as thermoplastic polymers. For example, the polymer-based material may comprise polyoxymethylene, POM, or polypropylene, PP, optionally comprising a reinforcing filler, such as glass fibers.

The protrusions 5 and the insert 6 may extend at different angles B and y with respect to the second plane M2. The insert 6 may extend essentially along a normal direction N2 of the second plane M2, preferably such that an insert angle y between the main, such as axial, direction A of the insert 6 and a direction along the second plane M2, such as along the second direction D2, is 75°≤γ≤105°, for example about 90°. In some embodiments, however, the insert angle y may deviate from the normal direction N2 by up to ±15°, such as being 75° C.≤γ≤105° or 80°≤γ≤100°. The insert groove 9 may extend in the same direction as the insert 6, whereby reference is made to the above values.

As shown in, e.g., FIGS. 4a-4f, 5a-5f, 6d-6f, 7a-7h and 8a-8j, the insert 6 and/or its body portion 16, such as its enveloping surface, may have a substantially cylindrical shape, although other shapes are equally conceivable.

Generally herein, the insert 6 may be displaceable and/or compressible along its axial direction A, see the arrows C1 and C2 in FIGS. 2a, 2d, 3a and 4a illustrating an inward and outward displacement and/or (de-)compression, respectively. For example, the insert may be axially flexible along the axial direction A. The insert 6 may assume an expanded state S1 and a compressed state S2. For example, the insert may be at least partly compressed, such as entirely uncompressed, in the expanded state S1. The insert 6 may be configured to return towards, such as to return entirely to, the expanded state S1 when compressed by means of a biasing force. Thereby, it may function as a compression spring. An extension F1, F2 of the insert 6 along the axial direction A may be smaller in the compressed state S2 than in the expanded state S1. A, preferably maximal, extension F1 (in the expanded state S1) may be 30-60 mm, such as 45-55 mm. A, preferably maximal, extension F2 (in the compressed state S2) may be 25-55 mm, such as 40-50 mm. Alternatively, or additionally, the compression F1-F2 may generally herein be 3-8 mm, such as 4-6 mm.

The insert may comprise a spring, such as a static load spring. As seen most clearly in FIGS. 4a-4c, 5a, 5d, 6d, 7c, 8a, 8d, 8e and 8h, the insert 6 may comprise a flexible, compressible member 6b, preferably in the form of a plurality of joined serpentine elements 6c, which, for example, may be S-shaped elements. The serpentine elements 6c may be connected to the body portion 16 of the insert 6, preferably in an integral manner (i.e., one piece). At least a part, such as an entirety, of the body portion 16 may be configured to be arranged in the insert groove 9 in the locked state, preferably engaging with a groove wall 9a and/or 9b of the insert groove 9. Preferably, the serpentine elements 6c are flexible. Moreover, the insert 6 may be configured to return towards the expanded state S1 when compressed by means of a biasing force of the serpentine elements 6c. The serpentine elements may thereby comprise alternating crests 6d and troughs 6e arranged along the axial direction A.

Adjacent serpentine elements 6c located along the same transverse side of the insert 6 may be separated by a space 6f along the axial direction A, at least in the expanded state S1, but preferably also in the compressed state S2.

In preferred embodiments, a, preferably maximal, width W2 of the recess 4 may be larger than a preferably maximal, width W4, W5 of the insert 6 and/or insert groove 9. For example, the width W4 of the insert 6 may be determined at the location of the projection(s) 8 (defined further below). The widths W2, W4, W5 may be determined along the second direction D2. Thereby, the insert 6 and/or insert groove 9 may be offset with respect to the recess 4 in the locked state. For example, a centre line CL1 of the insert 6 and/or insert groove 9 may be spaced along the second direction D2 from a centre line CL2 of the recess 4, wherein the centre lines CL1, CL2 extend along the first direction D1.

The first 1 and second 2 joinery components may be locked to each other by relatively displacing them in a locking direction 17, which extends essentially in parallel with the cavity direction P1 and/or the protrusion direction P2, preferably in a final phase of the locking. With reference to the first joinery component 1, one component of the locking direction 17 may include the first direction D1 and one component of the locking direction 17 may extend along the first plane M1, for example along the second direction D2 as shown in, e.g., FIG. 2a. Preferably, the third plane M3 is essentially arranged perpendicularly to the first plane M1 during locking. The locking may be accomplished without using a separate assembling tool.

During locking, the insert 6 may be compressed such that it assumes the compressed state S2, and, subsequently, the insert 6 may be at least partially expanded towards the expanded state S1 for locking the joinery components 1, 2. For example, the insert 6 may be entirely expanded to the expanded state S1. The insert 6 may be compressed during locking by means of a cooperation between the insert 6 and the first joinery component 1, preferably the mounting side 1a, see, e.g., FIG. 2a.

The insert 6 may be displaced during locking into the insert groove 7, preferably by being compressed such that it assumes the compressed state S2. Subsequently, the insert 6 may be displaced out from the insert groove 7, such that it at least partially is expanded towards the expanded state S1, for example entirely assuming the expanded state S1.

The protrusions 5 may each be received within the respective cavity 3 for locking the joinery components 1, 2.

Generally herein, the joinery arrangement 10 may extend along a primary X, a secondary Y, and a tertiary Z direction, which are perpendicular to each other. At least in the locked state, the primary X and tertiary Z directions may extend along the first M1 and second M2 planes, and the secondary direction Y may extend along a thickness direction of the first joinery component 1 and along the third plane M3.

The cavities 3 may be inclined with respect to the second direction D2, which, for example, may be parallel with the primary direction X. For example, the primary X and/or tertiary Z directions may be configured to extend in parallel with a subfloor 30 in which the joinery arrangement 10 or joinery assembly 20 is to be installed, cf. FIGS. 9a-9b, although other configurations are equally conceivable.

In some embodiments, the, preferably outer portion of the, protrusions 5 may be inclined in a direction away from the insert groove 9, see, e.g., FIGS. 1a-1c, 2a-2c, 3a and 6c. In some embodiments, the protrusions 5 may be inclined in a direction toward the insert groove 9, see, e.g., FIG. 9a. The inclinations in FIGS. 9a-9b may provide an improved locking of the joinery arrangement by means of an inward force towards a mounting wall 32 resulting from a downwardly directed gravitational pull on the joinery assembly 20, cf. the discussion below. In any of these scenarios, the cavities 3 may be inclined in correspondence with the inclinations of the protrusions 5. In yet some embodiments, some protrusions 5 may be inclined in a direction away from the insert groove 9 and some protrusions 5 may be inclined in a direction toward the insert groove 9, see, e.g., FIG. 6a.

Generally herein, the joinery components 1, 2, such as the faces 1b, 2b, 1c, 2c and/or side edges 1d, 2d, 1e, 2e and/or side portions 1f, 2f, 1g, 2g, may be rectangular or square, although other shapes are equally conceivable. In non-restrictive examples, a thickness T1, T2 of the joinery components 1, 2, such as along the secondary Y or tertiary Z direction, may be 10-32 mm, preferably 12-19 mm. Moreover, in non-restrictive examples, the dimensions of the faces 1b, 2b, 1c, 1c may be between 300 mm and 1000 mm, such as along both of the primary X and tertiary Z directions or both of the primary X and secondary Z directions.

The insert 6 comprises a retaining member 7, which comprises at least one projection 8, such as two projections 8 or even a plurality of projections 8, such as three to ten projections or four to eight projections (herein, not including the end section). The retaining member 7, preferably in the form of an outer retaining member 7′, may be configured to cooperate with the recess wall 4a in the locked state. At least one projection 8, such as at least two projections 8, may be configured to cooperate with the recess wall 4a in the locked state (see, e.g., FIG. 3b). Hence, the cooperating portion of the projections 8 may be part of the locking portion 6h and the locking surface 4c may be part of the cooperating recess wall 4a.

In the locked state, the locking portion 6h may cooperate with the locking surface 4c and a head surface 8d of the head portion 6g and a recess wall 4b may be separated by the play 15. The recess wall 4b may be arranged opposite to the cooperating recess wall 4a, for example along the second direction D2 in the locked state. The head surface 8d may be arranged in the inner 6j (or outer 6i) head portion. Preferably, the recess wall 4a, 4b is planar.

The retaining member 7 may be arranged in an end portion 14 of the insert 6 configured to face outwards from the insert groove 9. The retaining member 7 and/or the end portion 14 may extend from the body portion 16, preferably in an integral manner. The projections 8 may be arranged along the main direction A between a, preferably disc-shaped, longitudinal end section 6a and the body portion 16. A longitudinal extension of the retaining member 7 may be parallel with the main direction A of the insert 6. In some embodiments, the projections 8 may form corrugations on the insert 6.

Generally herein, the projections 8 may extend transversely, such as radially, outwards from a base surface 7a of the retaining member 7. The base surface 7a may include transversely innermost portions of the retaining member 8. In non-limiting examples, a height Q of the projections 8, preferably from the base surface 7a, may be at least 0.3 mm, preferably 0.3-1.0 mm, such as 0.4-0.8 mm. Moreover, a, preferably maximal, thickness G of the projections 8 may be at least 0.1 mm, preferably 0.1-0.8 mm, such as 0.2-0.6 mm. Also, a projection angle o of a top surface 8e of the projections 8 may be 100°-125°, such as 105°-115°, with respect to the main axis A.

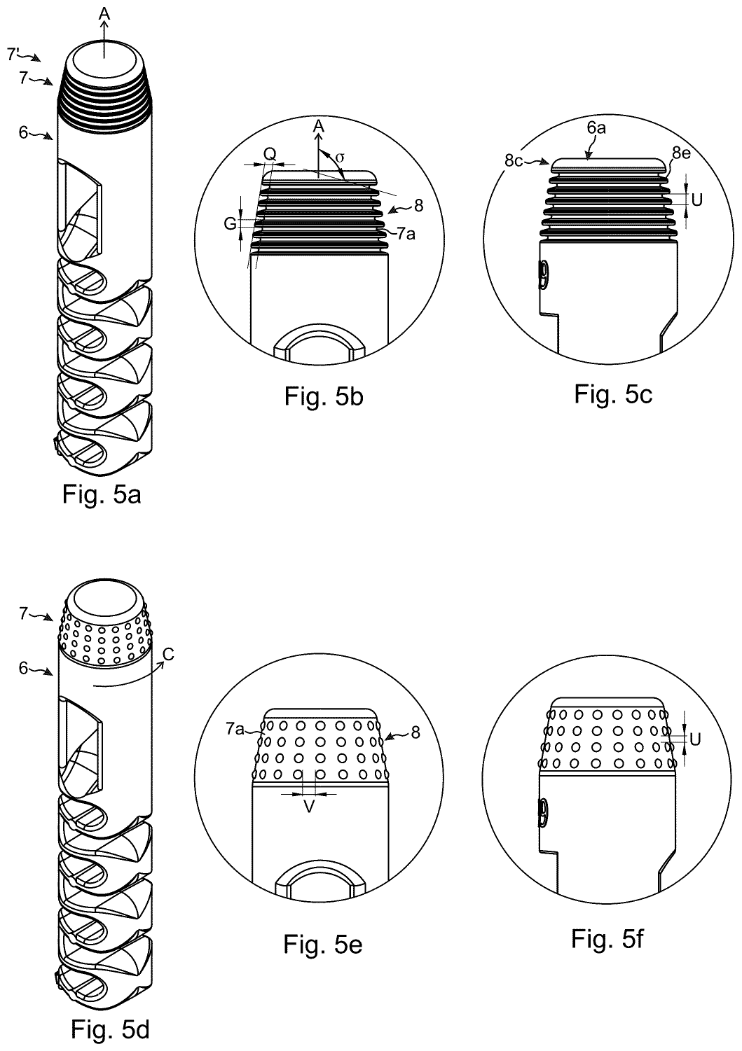

In some embodiments, the height Q may be constant along the main direction A of the insert 6, see, for example, FIGS. 5a-5f, 6d-6f, 7a-7h and 8h-8j. In some embodiments, the respective ones of the projections 8 may extend, from the base surface 7a by different heights Q along the main direction A of the insert 6, see, for example, FIGS. 3b, 4a-4f, 6d-6f, 7a-7h and 8a-8c. For example, the height Q may be larger in a direction towards the topmost portion 6k than in a direction towards the body portion 16. Generally herein, the height Q may be determined along a transverse (radial) direction TD of the insert 6.

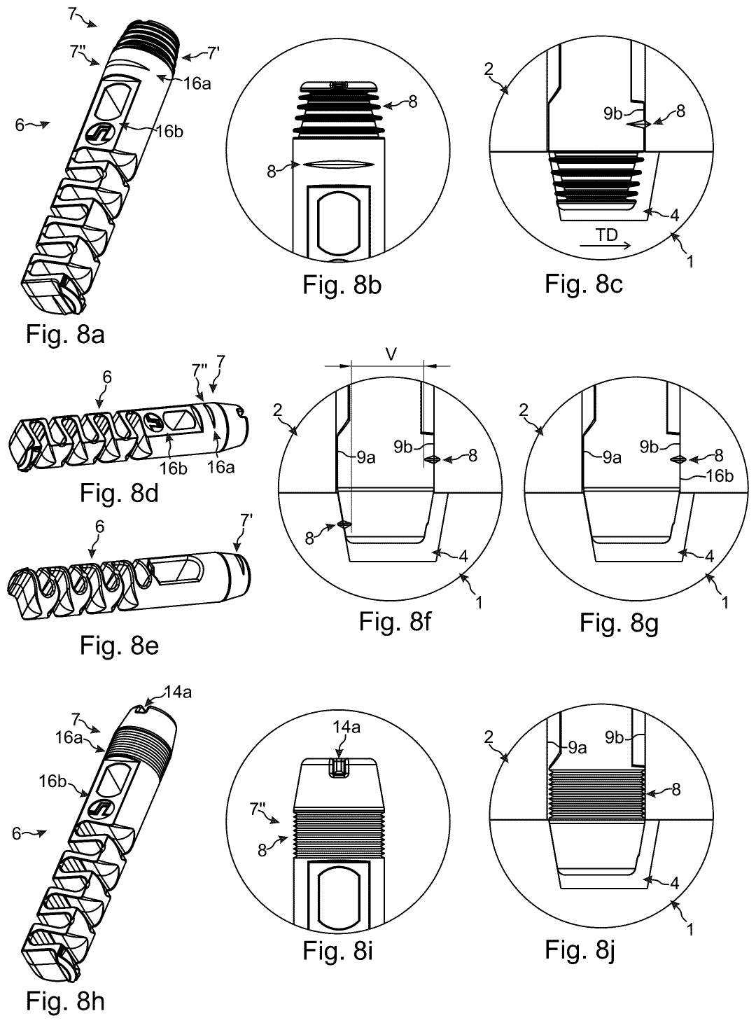

As shown in, e.g., FIGS. 4a-4f, 5a-5c, 6d-6e, 7a-7h, 8a-8c and 8h-8j, at least some, such as all, of the projections 8 may extend around an entire circumference of the retaining member 7, preferably along a circumferential direction C of the insert 6. For example, the projections 8 may be annularly shaped or disc shaped. In some embodiments, however, at least one or some, such as all, of the projections 8 may extend around a portion of the circumference of the retaining member 7, see, e.g., FIGS. 5d-5f and 8a-8g. In non-limiting examples, and as shown, the projections 8 may be arranged in a raster pattern or a lattice pattern.

The projections 8 may be formed by the same material as the insert 6, preferably in one piece therewith. The material may comprise a polymer-based material. The projections 8 may be rigid, preferably such that they are essentially nondeformable, especially during locking. For example, the material of the projections 8 may be more rigid than the material of the core 18 of the first 1 and/or the second 2 joinery components, for example being wood-based joinery components.

The projections 8 may be separated from each other along the main direction A by a spacing U, U1, U2. In some embodiments, and as illustrated in, e.g., FIGS. 4d-4f, 5a-5f, 6d-6f, 7a-7h and 8h-8j, the projections 8 may be evenly spaced such that the spacing U may be the same between all adjacent pairs of projections 8. In some embodiments, the spacing U1, U2 may vary between different adjacent pairs of projections 8. As illustrated in, e.g., FIGS. 4a-4c, 6d-6f, 7a-7h and 8a-8c, the spacing U1 between a first pair 8a of adjacent projections 8 may be smaller than the spacing U2 between a second pair 8b of adjacent projections 8. The first pair 8a may be arranged closer than the second pair 8b to the end section 6a. It is clear to the skilled artisan that there may be more than two pairs, such as a plurality, of adjacent projections 8 for which the spacings U become gradually smaller towards the end section 6a.

In yet some embodiments, the projections 8 may be separated from each other along the circumferential direction C of the insert 6 by a spacing V, see, e.g., FIGS. 5d-5f and 8d-8f, which show the spacing V in conjunction with the spacing U. The circumferential direction C may be perpendicular to the main direction A.

In non-limiting examples, the spacings U, U1, U2 and/or V may be 0.3-1.5 mm, such as 0.4-1.0 mm.

Transverse extensions E of the projections 8 may generally vary along the main direction A, such as decrease towards the end section 6a. Preferably, the retaining member 7 generally tapers in a direction towards the end section 6a. The end portion 14 may have a frustoconical shape. For example, an envelope 7b (which is a virtual surface) of the transverse extensions E may be arranged along straight line, e.g., such that the total envelope rotated around the main direction A is arranged along a frustoconical surface, see FIG. 4b. In some embodiments, and as shown in FIG. 4d, the envelope 7b of the transverse extensions E may be arranged along a concave curve, e.g., such that the total envelope is arranged along a curved truncated conical surface.

As shown in, e.g., FIGS. 4a-4c and 5a-5f, the transverse extension E of a topmost projection 8c, for example arranged in the end section 6a, may be smaller than the transverse extension E of the projections 8 arranged longitudinally inside of the topmost projection 8c along the main direction A. In some embodiments, however, and as shown in FIGS. 4d-4f, the topmost projection 8c may have a larger transverse extension E than the projections 8 arranged longitudinally inside of the topmost projection 8c along the main direction A.

Also, the recess wall 4a preferably tapers in a depth direction 12 of the recess 4. The depth direction 12 may extend perpendicularly to the first plane M1. For example, the recess wall 4a may have a frustoconical shape.

In some embodiments, at least some (e.g., all) of the projections 8 may extend, from the base surface 7a of the retaining member 7, up to a virtual frustoconical surface, which forms a non-zero angle & relative to the base surface 7a.

In non-restrictive examples, an inclination angle ϕ between the generally tapering retaining member 7, such as the envelope 7b of the transverse extensions E of the projections 8, and the main direction A may be 5°≤ϕ≤20°, such as about 10°. Alternatively, or additionally, in non-restrictive examples, a wall angle θ between the recess wall 4a and a normal direction N1 of the first plane M1 may be 5°≤θ≤20°, such as about 10°. Also, the base surface 7a may extend at an angle ω, for example of 5°-20°, against the main direction A. Thus, the angle ξ relative to the base surface 7a may correspond to the difference |ω-ϕ|.

In some embodiments, however, the recess wall 4a may extend along the first direction D1, preferably by having parallel recess walls 4a, 4b, see FIG. 6b. For example, the recess 4 may be shaped as a cylinder and/or the insert 6 may be substantially cylinder-shaped. Such configurations are imaginable in any of the embodiments herein, for example in any of FIGS. 1a-1c, 2a-2d, 3a-3b, 4a-4f, 5a-5f, 6a-6f, 7a-7h, 8a-8g and 9a-9b.

According to some embodiments, and as shown in, e.g., FIGS. 6c-6f, 7a-7h and 8a-8g, the at least one projection 8, such as a plurality of projections 8, of the retaining member 7, preferably in the form of an inner retaining member 7″, may be arranged in the body portion 16. In particular, the projection(s) 8 may be arranged in an axially outer segment 16a of the body portion 16 which is configured to face and/or engage with the groove wall 9a, 9b of the insert groove 9 in the locked state. For example, the axially outer segment 16a may be configured to be disposed proximate to the entrance of the insert groove 9 into the mounting area 2a. The body portion 16 may cooperate, such as engage, with each of a first groove wall 9a and an oppositely arranged second groove wall 9b.

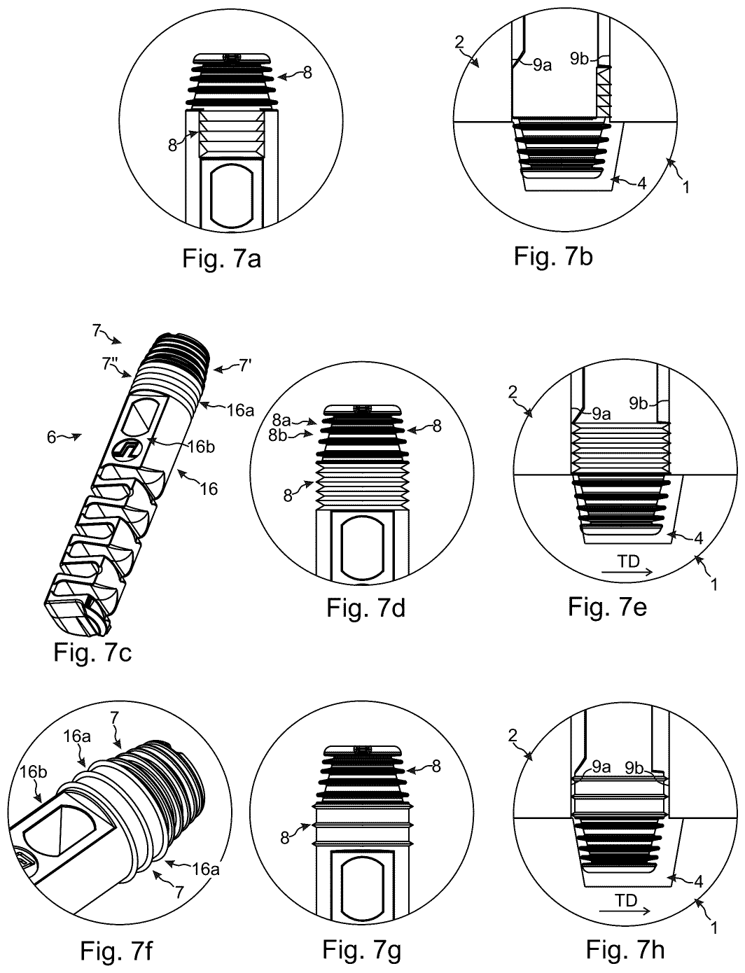

It is emphasized that any of the embodiments in FIGS. 7a-7b, 7c-7e, 7f-7h or 8a-8c, FIG. 8d together with FIGS. 8e-8f or FIG. 8g, or FIGS. 8h-8g may be used in joinery components 1, 2 of the type shown in, e.g., FIGS. 1a-1c, 2a-2c, 3a-3b and 6c.

The projections 8 may be configured to cooperate with the at least one groove wall 9a, 9b, such as each of the oppositely arranged groove walls 9a, 9b, and optionally configured to cooperate with the locking surface 4c, preferably arranged in the recess wall 4a. In a first example, as shown in FIGS. 8g-8j, the at least one projection 8 may be arranged in the body portion 16 only. Here, the head surface 8d of the, preferably generally tapering, head portion 6g may, for example, be substantially flat and/or smooth. Such an insert 6 may provide a smoother, such as gentler, unlocking of the joinery components 1, 2, while providing a more secure arrangement of the insert 6 in the insert groove 9. It is noted that the insert 6 in FIG. 8d may represent a frontal perspective view of the insert 6 in FIG. 8g, where the corresponding rear perspective view analogous to that in FIG. 8e does not comprise a projection 8 in the end portion 14. In a second example, and as shown in FIGS. 6c-6f, 7a-7h and 8a-8f, at least two, such as a plurality, projections 8 may be arranged in the body portion 16 as well as in the end portion 14 configured to cooperate with the recess 4. As described elsewhere herein, the end portion 14 in which a part of the retaining member 7 comprising the projection(s) 8 is arranged, may generally taper.

The outer 7′ and/or inner 7″ retaining member may extend only around a portion of the circumference of the retaining member 7, such as along the circumferential direction C, see, e.g., FIGS. 6d, 8a and 8d-8e. Alternatively, the outer 7′ and/or inner 7″ retaining member may extend around an entire circumference of the retaining member 7, see, e.g., FIGS. 6d, 7c, 7f, 8a and 8h.

The projection(s) 8 arranged in the axially outer segment 16a may extend transversely outside of an axially inner segment 16b of the body portion 16, see, e.g., FIGS. 6c-6f, 7a-7b, 7f-7h and 8a-8g. Alternatively, the projection(s) 8 arranged in the axially outer segment 16a may extend to, or transversely inside of the axially inner segment 16b, see, e.g., FIGS. 7c-7e and 8h-8j. The transverse extensions may extend along the transverse direction TD of the insert 6. For example, any of the relations above may be specified in a front view and/or a side view of the insert 6. In any of these embodiments, the axially outer 16 and inner 16b segments may be located on the same transverse side of the insert 6.

Generally herein, the action of the retaining member 7 may increase when the load is increased. As illustrated in FIG. 6c, when the first joinery component 1, such as the first face 1b, is loaded, a force F directed along the first direction D1 may be created, such that the first joinery component 1 may be displaced relative to the second joinery component 2 in a direction antiparallel to the first direction D1 and along the second direction D2 due to the inclined protrusions 5 arranged in the inclined cavities 3. Due to a resulting force RF from the recess 4 acting on the insert 6 along the second direction D2, the outer retaining member 7′ may become activated by means of an increased engagement strength with the recess wall 4a. The force RF may also cause the insert 6 to be pressed against the insert groove 9, such that an oppositely directed force RF' in the insert groove 9 may activate the inner retaining member 7″ by means of an increased engagement strength with the second groove wall 9b. The activation of the outer 7′ and inner 7″ retaining members by means of the load may counteract an unlocking of the joinery components 1, 2.

The quantities specified herein, especially the angles α, β, γ, σ, ϕ, θ, ω, ξ or the extensions, E, F1, F2, G, HL, K, L, Q, T1, T2, U, U1, U2, V, W1-W5, may be determined by means of a profile projector, for example from Mitutoyo or Dravitec AB. The joint gap J may be measured with a digital dial gauge.

FIGS. 9a-9b illustrate embodiments of a joinery assembly 20 comprising the joinery arrangement 10 and/or inserts 6 according to any of the embodiments shown in, e.g., FIGS. 1a-1c, 2a-2d, 3a-3b, 4a-4f, 5a-5f, 6a-6f, 7a-7h and 8a-8j and further comprising at least one additional joinery component 11, 2, 2′, such as a plurality of additional joinery components. In fact, this particular embodiment includes two joinery arrangements 10 with two second joinery components 2 locked to the same first joinery component 1. The mounting side 1a may be an inner first face 1b of the joinery assembly 20. The joinery assembly 20 may be a furniture assembly. For example, the furniture assembly may be a cabinet assembly or a shelf assembly. FIG. 9b illustrates a wall-mounted cabinet assembly comprising a first joinery component 1 which forms a bottom joinery component of the wall-mounted cabinet assembly, such as along the secondary direction Y. The wall-mounted cabinet assembly is arranged at a vertical distance 31 from the subfloor 30 and may be fixed to the mounting wall 32 by any means known to the skilled artisan, such as by screws and/or angle brackets.

By way of example, the additional joinery components 11, 2, 2′ may be selected from the group consisting of a side joinery component 2, a top joinery component 1′, and a backside joinery component 2′. The additional joinery components 11, 2, 2′ may be connected to each other and/or to the joinery arrangement 10 by means of any embodiment described herein, such as in any of FIGS. 1a-1c, 2a-2b and 3a-3b, or by any means known in the art, for example by screws or by means of inclined rod-shaped elements and insertion recesses as well as a compressible locking element and a recess, e.g., as disclosed in WO 2023/143756 A1. Optionally, one or several of the joinery components 1, 11, 2 may comprise a connecting channel 21 for connecting the backside joinery component 2′.

In any embodiment herein, the end portion 14 may comprise an indicator 14a, such as a notch, for indicating a rotational position of the insert 6 around the main axis A, cf. FIGS. 8h-8i.

### EXAMPLES

A reference set RO of reference samples and three sets R1, R2, R3 comprising samples of a joinery arrangement or joinery assembly were tested in accordance with a peak load testing method and an impact load testing method. Each sample in each of the sets R0, R1, R2, R3 comprised a first and a second joinery component in the form of panels with dimensions 130×16 mm×60 mm and 180 mm×300 mm×16 mm along the X, Y, Z directions, respectively, and had a core in the form of a particle board and a decorative layer comprising melamine formaldehyde resin. The first joinery component comprised recess having a tapering frustoconically shaped recess wall with a wall angle θ of 10°. A maximal width W2, corresponding to a diameter of the recess, was 11.2 mm. The sets R0, R1-R3 further comprised an insert consisting of pure POM without any filler and being designed identically, except for the head portions. The inserts had frustoconically shaped end portions and a maximal extension F1 of about 51 mm, and each head portion had a minimal transverse extension E of 4 mm, a head length HL of 5.3 mm, and an inclination angle ϕ of 10°. The reference set R0 comprised an insert without any projections, having a substantially smooth head portion in accordance with the embodiment in FIGS. 1a-1c of WO 2023/191694 A1, and having a surface roughness of 27 according to the standard VDI (Verein Deutscher Ingenieure). All projections in R1-R3 had G=0.3 mm perpendicularly to the base surface. The first set R1 comprised six evenly spaced projections (cf. FIGS. 5a-5c) with U=0.8 mm and Q=0.7 mm. The second set R2 comprised five evenly spaced separated projections arranged along a concave curve (cf. FIGS. 4d-4f) with U=0.8 mm and Q=0.7 mm. The third set R3 comprised four projections with spacings becoming gradually smaller towards the end section (cf. FIGS. 4a-4c) with 0.9 mm≤U≤1.3 mm, 0.5 mm≤Q≤1.0 mm, and the base surface extended at an angle ω=16°.

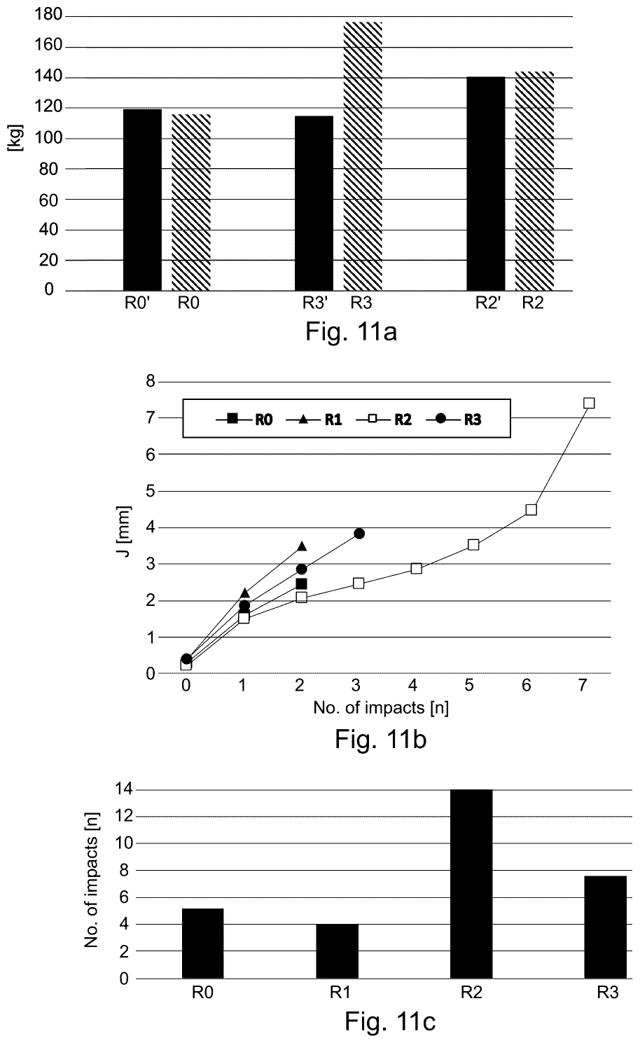

According to the peak load testing method, a strength of a locking device under an application of an excessive load on a sample of a bottom panel of a joinery assembly, such as being configured to be wall mounted, was estimated. The samples in the sets R0, R1-R3, were conditioned for the test at a temperature of 23±2° C. and a relative humidity of 50±5% RH for a minimum of 24h. Two samples of side panels were assembled to the bottom panel similarly to the joinery components 1, 2 in FIGS. 9a-9b and a sample of a top panel was assembled to the side panels similarly to the top joinery component 1′ in FIG. 9b (no backside panel was used). A hole was drilled in the top panel at a geometrical center so that a pressure bar could be freely inserted through the top panel. A load was applied on 100% of a depth and on 75% of a width (centered) of the bottom panel (corresponding to dimensions along the primary X and tertiary Z directions in, e.g., FIGS. 9a-9b). The resulting arithmetic mean static load in the form of a peak load at break was then measured for three samples of the joinery assembly in each of the sets R0, R2 and R3, and the results are presented in FIG. 11a (see the hatched bars). It is clear from FIG. 11a that the samples in the second R2 and third R3 sets were resistant to a higher load as compared to the samples of the reference set R0.

Other samples in sets R0′, R1′, R2′, R3′ were also tested in accordance with the peak load testing method and the impact load testing method. The samples of the sets R0′, R1′, R2′, R3′ were identical to those in the sets R0, R1, R2, R3, respectively, except that the recess was cylindrically shaped, hence having a recess wall with a wall angle θ of about 0°. A maximal width W2, corresponding to a diameter of the recess, was 11 mm. Such a cylindrical recess thus had a smaller contact area than the conical recess.

The resulting arithmetic mean static load in the form of a peak load at break was then measured for three samples of the joinery assembly in each of the sets R0′, R2′ and R3′, and the results are presented in FIG. 11a (see the solid bars). It may be deduced from FIG. 11a that the samples in the second set R2′ (or third set R3′) were resistant to a higher (or lower) load than the samples of the reference set R0′. It may also be deduced that while the samples in the second sets R2, R2′ could endure about the same load, the samples in the third set R3 were resistant to a higher load than the samples of the third set R3′. In other words, the performance of the conical recess was better than that of the cylindrical recess.

According to the impact load testing method, and with reference to the drawings in FIGS. 10a-10c where an associated test rig is detailed, a joint gap J along the first direction D1 (see FIG. 2a) of five assembled samples of each of the sets, R0, R1-R3 arranged in the rig resulting from a dropping weight was measured by means of a digital dial gauge. The result of the testing method indicated a mechanical endurance of the locking device under impact loads.

The method included the following steps for each assembled sample in the sets R0, R1-R3 after being conditioned as described above. The sample was arranged in the rig and the joint gap J was measured. As shown in FIGS. 10a-10c, a homogenous weight element 40 of the mass 0.740 kg in the form of a vertically aligned disc of diameter 80 mm and width 9.3 mm was repeatedly dropped in impact engagement with the first face of a side panel at a vertical distance of 100 mm from the sample of the bottom panel. The resulting joint gap J in the joint was measured after each impact, the arithmetic mean result of which is summarized in FIG. 11b. The dropping of the weight was repeated until a released state was achieved, when the topmost portion of the insert was situated at or above the first face extending along the mounting side of the bottom panel, such as when the bottom panel broke and/or when a complete disengagement of the insert from the recess was achieved.

The arithmetic mean number of impacts for achieving the released state is summarized in FIG. 11c.

In view of the above, it may be deduced that, for any given number of impacts, the resulting arithmetic mean joint gap J for the samples in the second set R2 (or each of the first R1 and third R3 sets) was smaller (or larger) than that in the reference set R0. Hence, the samples of the second set R2 (or the first R1 and third R3 sets) generated on average the highest (or lowest) friction between the insert and the recess. Furthermore, while the samples in the second R2 and third R3 sets on average endured a greater number of impacts than those in the reference set R0, the samples in the first set R1 endured a fewer number of impacts.

In fact, the friction of the samples of the second set R2 was found to be too high for some applications involving the particle board as a core, since an unlocking of some of these samples resulted in a breaking, such as chipping, of them. The samples were unlocked by means of an unlocking hole 22 as discussed above. On the other hand, the unlocking of the samples of the third set R3 was found to be less destructive and typically did not result in any damage of the samples. The inventors have therefore surprisingly found that, at least for some applications, e.g., involving a particle board as a core, the samples of the third set R3 may constitute a balanced compromise for providing a sufficiently high locking strength while maintaining the possibility to disassemble the joinery components with little or no damage.

Aspects of the disclosure have mainly been described above with reference to a few embodiments. However, as is readily appreciated by a person skilled in the art, other embodiments than the ones disclosed above are equally possible within the scope of the disclosure. For example, it is clear that in some embodiments the outer 6i and/or inner 6j head portion may cooperate with the recess wall 4b, such that there is no play 15.

1. A joinery arrangement comprising a first joinery component and a second joinery component configured to be locked to each other to obtain a locked state, wherein:
the first joinery component comprises:
at least one cavity arranged in a mounting side of the first joinery component and extending along a cavity direction at a cavity angle with respect to a first plane extending along the mounting side of the first joinery component, and
a recess arranged in said mounting side of the first joinery component; and
the second joinery component comprises:
at least one protrusion arranged in a mounting area of the second joinery component and extending along a protrusion direction at a protrusion angle with respect to a second plane extending along the mounting area of the second joinery component, and
an insert arranged in the mounting area of the second joinery component, the insert being displaceable and/or compressible along its main direction,
wherein said at least one cavity and said at least one protrusion are configured to cooperate with each other for locking the first and second joinery components to each other in a first direction perpendicular to said first plane,
wherein the recess and the insert are configured to cooperate with each other for locking the first and second joinery components to each other in a second direction along said first plane,
wherein the insert comprises a retaining member comprising at least one projection, such as a plurality of projections, and
wherein the joinery arrangement is configured such that, in the locked state:
the retaining member cooperates with a recess wall of the recess; and/or
the insert is arranged in an insert groove of the second joinery component, and the retaining member cooperates with a groove wall of the insert groove.

2. The joinery arrangement according to claim 1, wherein the projections are separated from each other along the main direction of the insert by a spacing.

3. The joinery arrangement according to claim 2, wherein the spacing between a first pair of adjacent projections is smaller than the spacing between a second pair of adjacent projections, the first pair being arranged closer than the second pair to an end section of the insert.

4. The joinery arrangement according to claim 1, wherein the projections are separated from each other along a circumferential direction of the insert by a spacing.

5. The joinery arrangement according to claim 1, wherein the projections extend around an entire circumference of the retaining member.

6. The joinery arrangement according to claim 1, wherein the retaining member generally tapers in a longitudinal direction towards an end section of the insert and/or wherein the recess wall tapers in a depth direction of the recess.

7. The joinery arrangement according to claim 1, wherein respective ones of the projections extend, from a base surface of the retaining member, by different heights.

8. The joinery arrangement according to claim 1, wherein at least some of the projections extend, from a base surface of the retaining member, up to a virtual frustoconical surface, which forms a non-zero angle relative to the base surface.

9. The joinery arrangement according to claim 1, wherein, in the locked state, a locking portion of the insert cooperates with a locking surface of the recess and wherein there is a play between a head surface of a head portion of the insert and a recess wall arranged opposite to the cooperating recess wall of the recess.

10. The joinery arrangement according claim 1, wherein the mounting side of the first joinery component is provided in a first face of the first joinery component and wherein the mounting area is provided in a first side edge of the second joinery component.

11. The joinery arrangement according to claim 1, wherein, during locking, the insert is configured to be compressed such that it assumes a compressed state, and wherein, subsequently, the insert is at least partially expanded towards an expanded state for locking the second joinery component to the first joinery component.

12. The joinery arrangement according to claim 1, wherein the second joinery component is configured to be locked to the first joinery component by relatively displacing the second joinery component with respect to the first joinery component in a locking direction extending essentially in parallel with at least one of said cavity direction and said protrusion direction.

13. The joinery arrangement according to claim 1, wherein the insert is arranged in an insert groove of the second joinery component.

14. The joinery arrangement according to claim 13, wherein the insert and/or an insert groove in which the insert is arranged essentially extends along a normal direction of the second plane.

15. The joinery arrangement according to claim 1, wherein the retaining member comprises an outer and/or an inner retaining member, the outer and inner retaining member being configured to cooperate with the recess and the insert groove, respectively, in the locked state.

16. The joinery arrangement according to claim 13, wherein the at least one projection is arranged in a body portion of the insert, the body portion being configured to cooperate with a groove wall of the insert groove in the locked state.

17. The joinery arrangement according to claim 1, wherein the insert comprises a plurality of joined serpentine elements.

18. The joinery arrangement according to claim 1, wherein the protrusion angle is smaller than the cavity angle in an unlocked state of the first and the second joinery components.

19. The joinery arrangement according to claim 1, wherein the first and second joinery components are furniture components, and wherein the joinery arrangement is configured to be included in a furniture assembly.

20. A joinery assembly comprising the joinery arrangement according to claim 1, further comprising at least one additional joinery component.
